(19) United States
(12) Patent Application Publication
(10) Pub. No.: US 2006/0121326 A1
(43) Pub. Date: Jun. 8, 2006

(54) Fuel cell system and control method thereof

(75) Inventors: Hidehiko Hiramatsu, Nagoya (JP); Shingo Morishima, Toyota-shi (JP); Takeshi Yamamoto, Ama-gun (JP)

Correspondence Address: OLIFF & BERRIDGE, PLC, P.O. BOX 19928, ALEXANDRIA, VA, 22320, US

(73) Assignee: DENSO CORPORATION, Kariya-city (JP)

(21) Appl. No.: 11/283,722

(22) Filed: Nov. 22, 2005

(30) Foreign Application Priority Data
Dec. 2, 2004 (JP) 2004-349930

(51) Int. Cl. H01M 8/04

(52) U.S. Cl. 429/25; 429/24; 429/34; 429/13

(57) ABSTRACT

A fuel cell system with a fuel cell (FC stack) has an off gas circulation path to the fuel cell, an off gas exhaust unit, and an off gas pressure sensor. The system measures physical properties such as a pressure and temperatures of the off gas at various timings before and after the purging, and the calculator in the system calculates an off gas density and a hydrogen concentration in the off gas based on the measured physical properties. The system determines optimum conditions such as a start-up time and an operation period of time for the purging based on the measured and calculated values.

### CROSS-REFERENCE TO RELATED APPLICATION

This application is related to and claims priority from Japanese Patent Application No. 2004-349930 filed on Dec. 2, 2004, the content of which are hereby incorporated by reference.

### BACKGROUND OF THE INVENTION

1. Field of the Invention

The present invention relates to a fuel cell system with a fuel cell (FC stack) and a control method thereof, that generate an electrical energy in an electrochemical reaction of combining a hydrogen and oxygen, and suitably applicable to movable bodies, using a fuel cell as an electric power source, such as an automotive vehicles, an electric vehicle, a marine vessel, portable power generators, small-sized generators for home use, and other mobile devices.

2. Description of the Related Art

As is known, there is a conventional fuel cell system which sucks an off gas exhausted from a hydrogen electrode (or a negative electrode) of the FC stack by a circulation pump, and combine the exhausted one with a supplied fuel from a hydrogen supply tank, and then re-circulates the combined one to the FC stack. An ejector pump is widely used as the circulating pump because the use of the fluid energy of a fuel supplied can reduce a power consumption of the system.

It has been known that a hydrogen concentration in the circulating off gas is reduced because of leakage of air gas including a nitrogen gas through electrolyte membranes in the FC stack and because of the accumulation of impurities such as the nitrogen gas in a circulating path through which the off gas flows, and this thereby reduces the output power of the FC stack in the fuel cell system. The lacking of a necessary amount of the hydrogen gas to be supplied to the FC stack causes the lacking of the fuel at the hydrogen electrode of the FC stack, so that the FC stack becomes unstable and a disturbance of the electrical power generated by the FC stack occurs. This causes the deterioration of the electrolyte membranes laminated in the FC stack.

In order to avoid the conventional drawbacks described above, for example, there were proposed two conventional techniques regarding a fuel cell system. One is disclosed in the Japanese laid-open patent application JP-S54-144937 which is capable of exhausting to outside impurities with an off gas of a trace amount in proportion to the amount of consumption of the fuel gas. The other is disclosed in the Japanese laid-open patent application JP-2000-243417 which is capable of exhausting to outside impurities by performing a purging operation to open a purge valve mounted on the hydrogen gas circulating system.

However, the configuration of the former conventional system has to exhaust to outside of the device the off gas containing a hydrogen gas every regular interval, and it thereby reduces the efficiency of generation of electrical energy in a FC stack, even if it is not necessary to exhaust the off gas under a higher concentration of the hydrogen in the off gas.

Further, because the latter system has the configuration capable of opening a purge valve according to the magnitude of a voltage drop of the electrical energy generated in the FC stack, it can suppress the exhaust amount of the hydrogen gas. However, the latter system causes the deterioration of the FC stack in a short time interval because of a possibility in which a voltage drop in the FC stack occurs even though in a short period of time.

### SUMMARY OF THE INVENTION

It is an object of the present invention to provide a new and improved fuel cell system with a simple configuration capable of measuring and calculating a hydrogen concentration and physical properties relating to the hydrogen concentration at an outlet side of a hydrogen electrode in a FC stack of the system.

Another object of the present invention is to provide the fuel cell system capable of suppressing an amount of a hydrogen gas exhausted through an off gas circulation path or an exhaust path for the off gas in the system.

To achieve the above purposes, the present invention provides a fuel cell system with a fuel cell generating electrical energy in an electrochemical reaction of hydrogen and oxygen therein.

The fuel cell system has an off gas path, an off gas exhaust unit, an off gas pressure detector, and an off gas physical property calculation with a control function. The off gas path is configured to exhaust an off gas containing impurities other than the hydrogen and a residual hydrogen not reacted during the electrochemical reaction in the fuel cell. The off gas exhaust unit is configured to exhaust the off gas to outside through the off gas path during a first period of time. The off gas pressure detector is configured to detect an off gas pressure value in the off gas path. The off gas physical property calculator is configure to calculate a change value between off gas pressure values before and after the purging of the off gas performed through the off gas exhaust unit, and to calculate an off gas density based on the change value and the off gas pressure value before the purging.

With a simple configuration and manner of the fuel cell system of the present invention, it is possible to obtain a hydrogen concentration in the off gas and an off gas density based on physical properties measured and calculated, relating to the hydrogen concentration, such as a magnitude of a pressure decrease of the off gas.

### BRIEF DECSRIPTION OF THE DRAWINGS

For a better understanding of the present invention and to show how the same may be carried out into effect, there will now be described by way of example only, specific embodiments and methods according to the present invention with reference to the according to the present invention.

FIG. 1 is a schematic diagram showing an entire configuration of a fuel cell system according to a first embodiment of the present invention;

FIG. 2 is a flowchart showing a purging process performed by the system of the first embodiment;

FIG. 3 is a diagram showing a pressure change of an off gas before and after the purging process for the off gas in the first embodiment;

FIG. 4 is a diagram showing a relationship between an off gas density and a magnitude of a pressure decrease before and after the purging process in the first embodiment;

FIG. 5 is a diagram showing a characteristic relationship between an off gas density and a period of time until the initiation of a following purging;

FIG. 6 is a flowchart showing a purging process controlled by a purge controller and a calculator in a fuel cell system according to a second embodiment of the present invention;

FIG. 7 is a diagram showing a pressure change of an off gas in an off gas circulation path before and after a supplemental exhaust process through a purging valve.

FIG. 8 is a schematic diagram showing an entire configuration of a fuel cell system according to a third embodiment of the present invention;

FIG. 9 is a flowchart showing a purging process controlled by an exhaust control unit and a calculation unit of the third embodiment.

FIG. 10 is a diagram showing a pressure change of an off gas in an off gas circulation path before and after the exhaust of the off gas through the secondary valve of a small-size in the third embodiment;

FIG. 11 is a diagram showing a relationship between a hydrogen concentration in the off gas and a period of time necessary for the purging process in the third embodiment;

FIG. 12 is a schematic diagram showing an entire configuration of a fuel cell system according to a fourth embodiment of the present invention;

FIG. 13 is a flowchart showing an abnormal state diagnosis process performed by the system of the fourth embodiment;

FIG. 14 is a diagram showing a pressure change of an off gas before and after a purging process in the fourth embodiment;

FIG. 15 is a diagram showing a relationship between a magnitude of a pressure increase in a pressure detection tank and an off gas density of the fourth embodiment;

FIG. 16 is a schematic diagram showing an entire configuration of a fuel cell system according to a fifth embodiment of the present invention;

FIG. 17 is a flowchart showing a permission process for an electrical energy generation in the system of the fifth embodiment;

FIG. 18 is a diagram showing a pressure change in the pressure detection tank before and after opening of a small-sized valve in the fifth embodiment;

FIG. 19 is a schematic diagram showing an entire configuration of a fuel cell system according to a sixth embodiment of the present invention;

FIG. 20 is a flow chart showing a purging process in the system of the sixth embodiment; and

FIG. 21 is a diagram showing a relationship between an off gas density and a supply pressure of hydrogen gas to the fuel cell.

### DETAILED DESCRIPTION OF THE PREFERRED EMBODIMENTS

Hereinafter, various embodiments of the present invention will be described with reference to the accompanying drawings. In the following description of the various embodiments, like reference characters or numerals designate like or equivalent component parts throughout the several views.

The following first to sixth embodiment will explain the cases in which the fuel cell system of the present invention is applied to an electric vehicle or a fuel cell vehicle equipped with a fuel cell (FC stack) as an electric power source.

### First Embodiment

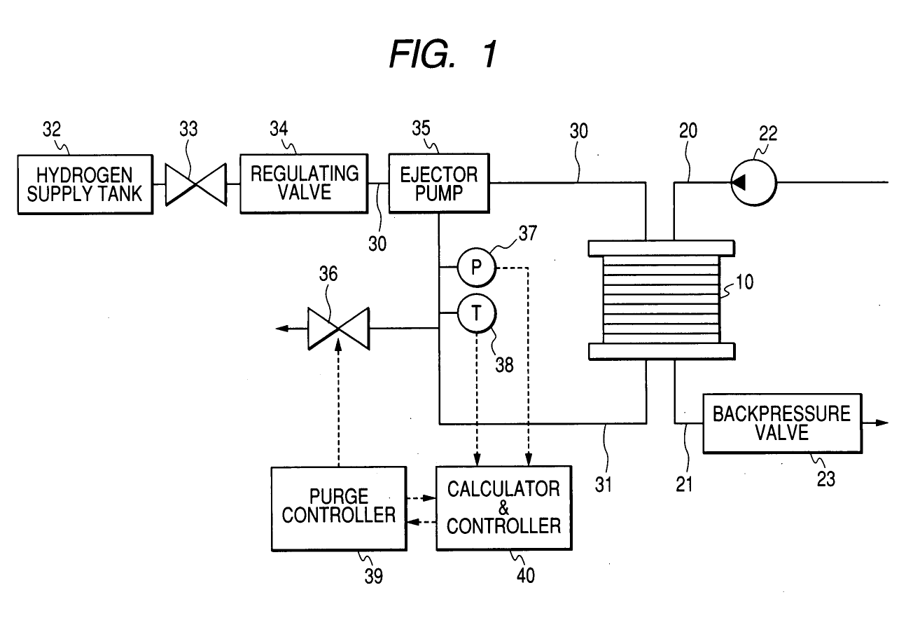

A description will now be given of the features of a fuel cell system according to a first embodiment of the present invention with reference to FIG. 1 to FIG. 5.

FIG. 1 shows the entire configuration of the fuel cell system according to the first embodiment of the present invention. In FIG. 1, the fuel cell system has a fuel cell (FC stack) 10 that generates an electrical energy in an electrochemical reaction of a hydrogen and an oxygen. The fuel cell 10 supplies the electrical energy generated to a motor mounted on a vehicle, a secondary battery, and supplementary electrical equipments (omitted from drawings).

In a case of the first embodiment, the fuel cell 10 is a polymer electrolyte fuel cell (PEFC) in which a plurality of unit cells are laminated and stacked in multilayered structure. Each unit cell has a configuration in which an electrolyte membrane is sandwiched between a pair of electrodes. Each cell generates an electrical energy by an electrochemical reaction of hydrogen and oxygen.

Hydrogen electrode: H₂-->2H⁺+2e⁻, and

Oxygen electrode: 2H⁺+½O₂+2e⁻-->H₂O.

A usual fuel cell system is equipped with an air supply path 20 through which the air (oxygen) flows in the fuel cell 10 and an air exhaust path 21 through which the air flowing out from the fuel cell 10 is exhausted to outside.

The air supply path 20 is equipped with an air supply device 22 that compresses air and supplies the compressed one to the fuel cell 10. In the embodiment, the air supply device 22 is implemented by a compressor, for example. The air exhaust path 21 is equipped with a backpressure valve 23 capable of regulating an air pressure in the fuel cell 10 by adjusting a flow sectional area of the air exhaust path 21.

The fuel cell system is further equipped with a hydrogen supply path 30 and an off gas circulation path 31 as an off gas path provided at the hydrogen electrode end of the fuel cell 10. Through the hydrogen supply path 30 a hydrogen gas as a fuel gas is supplied to the fuel cell 10. Through the off gas path the off gas containing impurities other than the hydrogen and residual hydrogen which has not been reacted during the electrochemical reaction in the fuel cell 10 is circulated to the fuel cell 10.

The off gas circulation path 31 joins the outlet end of the hydrogen electrode of the fuel cell 10 to the hydrogen supply path 30.

FIG. 1 shows the off gas circulation path 31 as an example in configuration of the off gas exhaust path according to the present invention.

The hydrogen supply path 30 is equipped with a hydrogen supply tank 32 (as a hydrogen supply unit), a valve 33 to open and close the hydrogen supply path 31, and a regulating valve 34 to regulate a pressure of the hydrogen to be supplied to the fuel cell 10.

In this embodiment, a high-pressure hydrogen tank filled with the hydrogen gas is provided as a high pressure hydrogen tank.

An ejector pump 35 is installed in a junction of the hydrogen supply path 30 and the off gas circulation path 31 so as to circulate the off gas to the fuel cell 10. The ejector pump 35 sucks the off gas using fluid energy of the hydrogen gas supplied from the hydrogen supply tank 32 so as to circulate the off gas.

The off gas circulation path 31 is equipped with a pressure sensor 37 as an off gas pressure detector or an off gas detection means and a temperature sensor 38 to measure a pressure and a temperature of the off gas in the off gas circulation path 31, respectively.

With the passage of time of the generation of the electrical energy in the fuel cell 10, impurities such as nitrogen are accumulated at the hydrogen electrode of the fuel cell 10, so that the concentration of the impurities contained in the off gas from the fuel cell 10 is increased and the concentration of the hydrogen thereby is decreased. In order to avoid this drawback, this embodiment performs the purging of the off gas at a given timing by opening a purging valve 36 for a given timing period so as to exhaust a part of the off gas with a lower hydrogen concentration in the off gas circulation path 31 to outside of the system. In the first embodiment, the purging valve 36 is a valve of an orifice diameter of 6 mm, and the opening period of time of the purging valve 36 during the purging is about 300 msec. The purging valve 36 is an example of the off gas exhaust unit, the pressure sensor 37 is also an example of the off gas pressure detector (or off gas pressure detection means), and the temperature sensor 38 is an example of the off gas temperature detector according to the present invention. The fuel cell system is further equipped with a purge controller 39 as a purge control unit and a calculator 40 with a control function as an off gas physical property calculator (or an off gas pressure change calculation means and an off gas density calculating means). The purge controller 39 instructs the purging valve 36 to perform its opening/closing operation. The calculator 40 calculates an off gas density.

The off gas density is obtained using an orifice diameter of the purging valve 36, a flow rate coefficient, a magnitude of the pressure decrease of the off gas, and so forth. The flow rate coefficient is determined according to a type of the purging valve 36.

The flow rate G of the off gas can be obtained by the following equation (1) with a molar mass.
G=226·Cv·A·{Pno·(Pni−Pno)·(273/T)·(28.8/M)}^{1/2} (1),
where A is an orifice diameter of the purging valve 36, Pni is a pressure value of the off gas at the inside of the purging valve 36, Pno is a pressure of the off gas at the outside of the purging valve 36, and M is a molar mass of the off gas. Through the first to sixth embodiments, the off gas density are equivalent in meaning to a molar mass of the off gas.

Because the flow rate G of the off gas is obtained only by the difference Pni−Pno of the pressure of the off gas across the purging valve 36, the off gas density or the off gas molar mass of the off gas can be obtained using the off gas temperature T measured and the difference of the pressure of the off gas across the purging valve 36.

If the off gas contains the hydrogen and the nitrogen as impurity, the hydrogen concentration contained in the off gas is calculated using the molar mass of the off gas. The hydrogen concentration means a value obtained by dividing a number of moles of the hydrogen by a number of moles of the whole off gas. Using the following equation (2) the molar mass M under the condition that the off gas contains only both the hydrogen and the nitrogen can be obtained.
M=2×X_{H2}+28X_{N2} (2),
where X_{H2} is a hydrogen concentration and X_{N2} is a nitrogen concentration. Since the nitrogen concentration X_{N2} in the equation (2) means X_{N2}=1−X_{H2}, the hydrogen concentration can be obtained using the equation (2). The purge controller 39 is used in the embodiment as a concrete example of the purging control unit. The calculator 40 of the embodiment comprises in function an off gas pressure change calculation unit and an off gas density unit.

In general, the more the concentration of the hydrogen, the less the off gas density will be. Thus, the hydrogen concentration is inversely proportional to the off gas density. Because the off gas density is a physical property relating to the hydrogen concentration in the off gas, the first embodiment uses the off gas density instead of the hydrogen concentration in order to detect the necessity of the purging for the off gas.

The purge controller 39 and the calculator 40 can be realized with an available microcomputer including a CPU (a central processing unit, omitted from diagrams), a ROM (a read only memory, omitted from diagrams), a random access memory and the like, and its peripheral devices. The calculator 40 inputs a value of the off gas pressure detected by the pressure sensor 37 and a value of the off gas temperature detected by the temperature sensor 38, then calculates the off gas density based on them, and outputs the calculation result to the purge controller 39. Based on the off gas density as the calculation result, the purge controller 39 transmits the instruction to the purging valve 36 so as to perform the opening/closing operation.

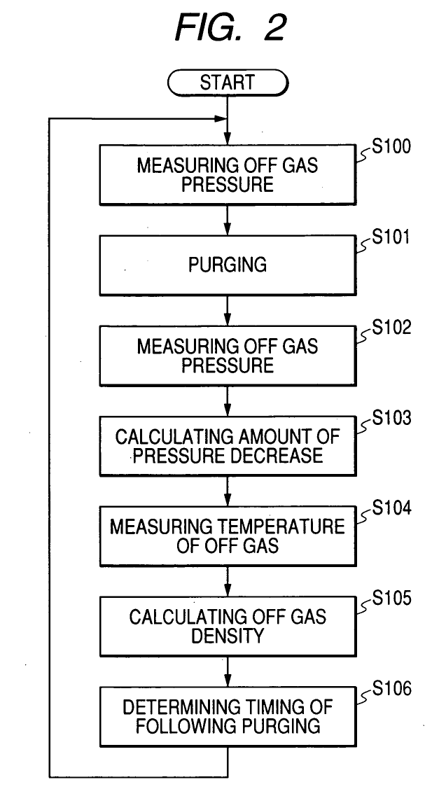

Next, a description will be given of the purge operation in the fuel cell system having the configuration described above with reference to FIG. 2 to FIG. 5.

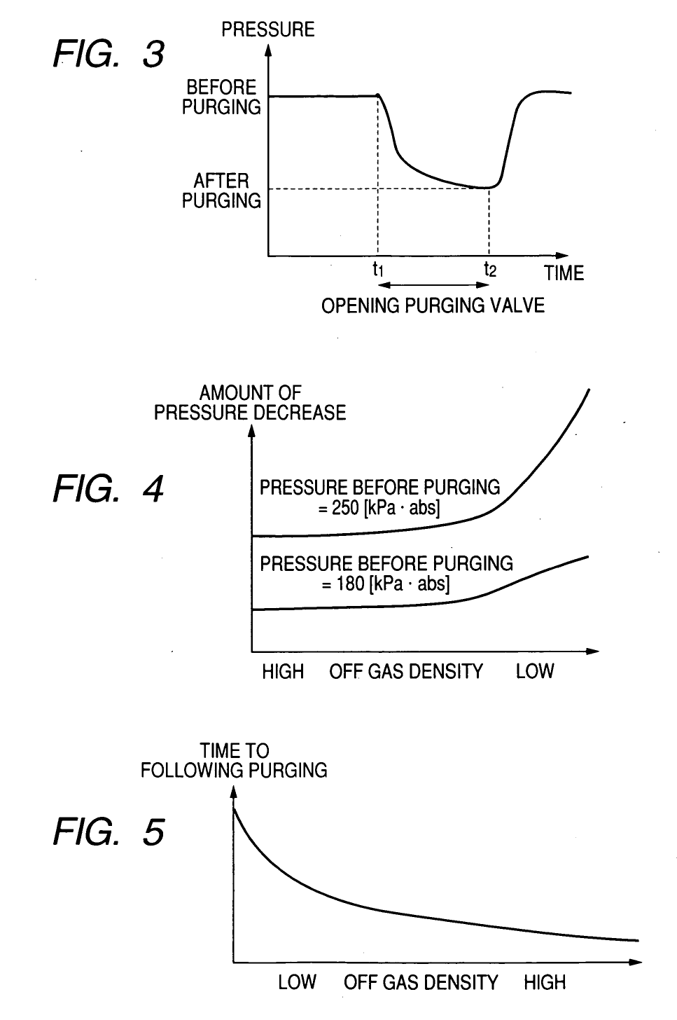

FIG. 2 is a flowchart showing a purging process performed by the system of the first embodiment, and FIG. 3 is a diagram showing a pressure change of the off gas in the off gas circulation path 31 before and after the purging process for the off gas.

First, the pressure sensor 37 measures the off gas pressure before the purging (S100). In the first embodiment, the pressure sensor 37 measures the off gas pressure at a timing t1 immediately before the opening of the purging valve 36. Following, the purging valve 36 is open for a given period of time, 300 msec in the embodiment (S101). This purging decreases the off gas pressure because a part of the off gas is exhausted to the outside from the off gas circulation path 31 through the purging valve 36.

Following, the pressure sensor 37 measures the off gas pressure after the purging (S102), for example, at a timing t2 immediately following the closing of the purging valve 36 in the first embodiment. After the closing of the purging valve 36, the off gas pressure in the circulation path 31 increases because newly off gas is supplied from the fuel cell 10 to the off gas circulation path 31. In other words, although the off gas containing a high concentration of the impurity is exhausted to the outside during the purging, the hydrogen concentration in the circulation path 31 is increased because the off gas containing the hydrogen of a high concentration is supplied to the off gas circulation path 31 from the fuel cell 10.

Next, the calculator 40 calculates a magnitude of the pressure decrease of the off gas by subtracting the pressure of the off gas after the purging from the pressure value of the off gas before the purging (S103). The temperature sensor 38 measures the temperature of the off gas in the circulation path 31 (S104). The calculator 40 then calculates the off gas density based on the magnitude of the pressure decrease of the off gas (S105). That is, the off gas density can be obtained using the orifice diameter of the purging valve 36, the flow rate coefficient, the off gas pressure before purging and the pressure decrease of the off gas.

Here, the calculation process of the off gas density will be explained.

FIG. 4 is a diagram showing a relationship between the off gas density and the magnitude of the pressure decrease before and after the purging process. FIG. 4 shows two cases, the off gas pressures before the purging are 250 kPa·abs and 180 kPa·abs.

From FIG. 4, it is apparently there is a strong relationship between the off gas density and the magnitude of the pressure decrease before and after the purging process. This means that a mole flow rate of the off gas flowing through the purging valve 36 depends on a composition of the off gas, namely the off gas density. As a concrete example, when the purging valve 36 of a same orifice diameter opens for a same period of time under a same off gas pressure before the purging, the less concentration the off gas has, the more mole flow rate the off gas has through the off gas circulation path 31. On the contrary, the more concentration the off gas, the more the mole flow rate has through the off gas circulation path 31.

As a result, the lower the off gas density, the higher the pressure decrease of the off gas will be, and the higher the off gas density, the lower the pressure decrease of the off gas will be.

In other words, the higher the concentration of the hydrogen in the off gas, the higher the pressure decrease of the off gas will be. The lower the concentration of the hydrogen in the off gas, the lower the pressure decrease of the off gas will be.

In addition, as shown in FIG. 4, a correlation between the off gas density and the pressure decrease of the off gas before and after the purging is changed according to the pressure of the off gas before the purging. In a concrete example, even though there is a same off gas density, the higher the pressure of the off gas before the purging, the higher the pressure decrease of the off gas will be, and the lower the pressure of the off gas before the purging, the lower the pressure decrease of the off gas will be.

The first embodiment provides in advance a first map (or a first table) in which the off gas density, the pressure decrease of the off gas before and after the purging, and the off gas pressure before the purging are related to each other. The first map is stored in the ROM (omitted from drawings) in the calculator 40. The calculator 40 calculates the off gas density using the first map based on the magnitude of the pressure decrease of the off gas that is calculated in the step S102. The off gas density immediately following the purging can be obtained.

Next, the timing to perform the following purging is determined (S106). The timing for the following purging is determined as the timing immediately before the occurrence of the voltage drop of the fuel cell 10 caused by decreasing the hydrogen concentration in the off gas.

FIG. 5 is a diagram showing a characteristic relationship between the off gas density and the period of time until the initiation of the following purging.

As shown clearly in FIG. 5, the higher the off gas density, the shorter the period of time until the following purging will be. On the contrary, the lower the off gas density, the longer the period of time until the following purging will be.

That is, the state of a low density of the off gas means that the hydrogen concentration is high and the impurity concentration in the off gas is low. In this state, a long period of time to initiate the following purging is determined and set because it becomes a long period of time to take the state in which the impurity concentration in the off gas becomes high and the hydrogen concentration becomes low in the course of the generation of the electrical energy in the fuel cell 10.

On the contrary, if the off gas density is high, namely the off gas is under the condition of the low hydrogen concentration and the high impurity concentration, a short period of time to initiate the following purging is determined and set because it becomes a short period of time to take the state where the impurity concentration in the off gas becomes high and the hydrogen concentration becomes low in the course of the generation of the electrical energy in the fuel cell 10.

It can be obtained experimentally in advance the relationship between the off gas density immediately following the purging shown in FIG. 5 and the period of time until the initiation of the following purging. The first embodiment provides a ROM (omitted from drawings) in the purge controller 39 which stores a second map or a second table of a relationship between the off gas density and the period of time until the initiation of the following purging. The purge controller 39 determines the period of time until the initiation of the following purging using the secondary map stored in the ROM.

As described above in detail, according to the first embodiment it is possible with a simple configuration to measure the pressure decrease of the off gas before and after the purging process and thereby to obtain the off gas density as one of physical properties relating to the hydrogen concentration in the off gas. This means it is also possible to obtain with a simple configuration the off gas density at the hydrogen electrode of the fuel cell 10.

Further, it is possible with a simple configuration to calculate the hydrogen concentration in the off gas at the hydrogen electrode of the fuel cell 10 based on the off gas density.

In addition, because the period of time until the initiation of the following purging is obtained based on the off gas density or the hydrogen concentration, it is possible to suppress the amount of the hydrogen to be exhausted to the outside through the purging process based on the off gas density or the hydrogen concentration, and possible to initiate the purging process before any occurrence of the voltage drop of the fuel cell 10.

### Second Embodiment

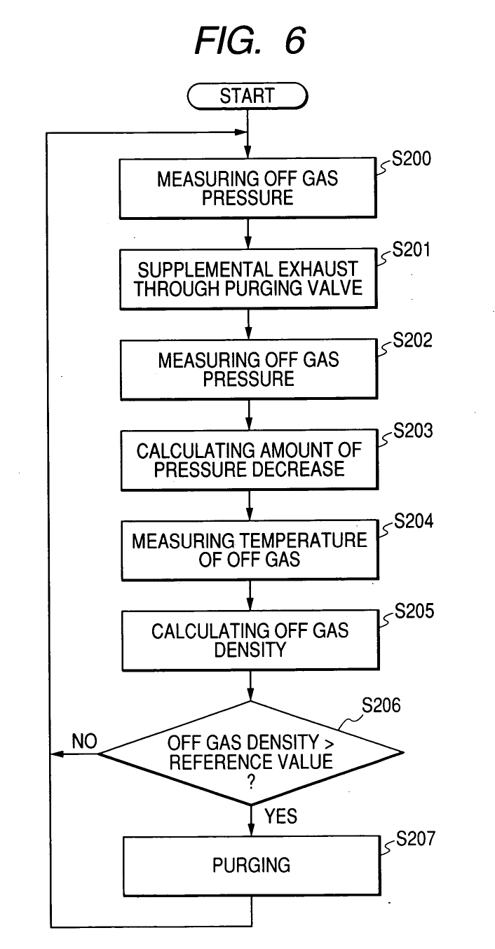

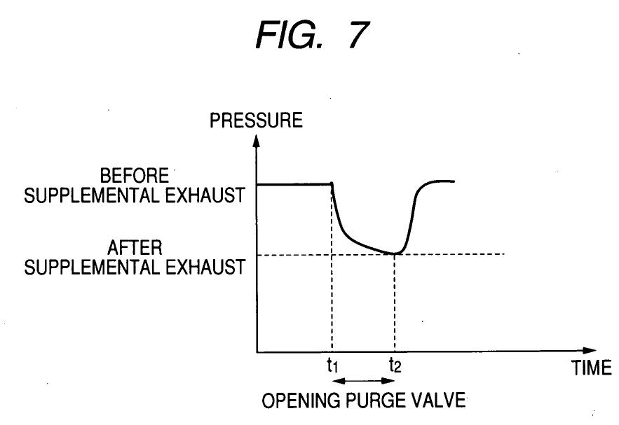

Next, a description will now be given of the feature of the fuel cell system according to the second embodiment of the present invention with reference to FIG. 6 and FIG. 7.

When compared with the first embodiment, the second embodiment performs a supplemental exhaust through the purging valve 36 in order to obtain the off gas density before the purging. Because the fuel cell system according to the second embodiment is the same in configuration as that of the first embodiment, the explanation thereof is omitted here. The difference operation to the first embodiment will be explained.

The purging process in the second embodiment will be explained with reference to FIG. 6 and FIG. 7.

FIG. 6 is a flowchart showing the purging process controlled by the purge controller 39 and the calculator 40 with a control function as the off gas physical property calculator in the fuel cell system of the second embodiment.

FIG. 7 is a diagram showing a pressure change of the off gas in the off gas circulation path 31 before and after the supplemental exhaust process through the purging valve 36.

The following processes are repeatedly performed every a given time elapsed (about every five minutes).

First, the pressure sensor 37 measures the pressure of the off gas before the supplemental exhaust through the purging valve 36 (S200). In this embodiment, the pressure sensor 37 measures the off gas pressure at a timing t1 immediately before the initiation of the supplemental exhaust through the purging valve 36 (S201). The period of time for the supplemental exhaust through the purging valve 36 is set in advance to a period of time (50 m sec in this embodiment) that is shorter than that of the purging process. In the supplemental exhaust, a part of the off gas is exhausted to the outside from the off gas circulation path 31 through the purging valve 36, and a slight amount of the pressure of the off gas is thereby decreased.

Next, the pressure sensor 37 measures the pressure of the off gas immediately following the supplemental exhaust through the purging valve 36 (S202). In the embodiment, the pressure sensor 37 measures the pressure of the off gas at a timing t2 (see FIG. 7) that is immediately following the closing of the purging valve 36. The calculator 40 calculates a pressure decrease of the off gas by subtracting the pressure value of the off gas at the timing t2 from that at the timing t1 (S203). The temperature sensor 38 measures a temperature of the off gas at the timing t2 (S204). The calculator 40 calculates the off gas density based on the pressure decrease of the off gas and the temperature measured.

Because the calculation process of the off gas density based on the pressure decrease of the off gas in the second embodiment is the same as that of the first embodiment, the explanation thereof is omitted here.

Next, the controller 39 judges whether the off gas density calculated is higher than that of a given off gas density (S206), where the given off gas density is a reference value for judging a necessity to initiate the purging. The given off gas density is set to a lower limit of the off gas density at which no voltage drop of the fuel cell 10 occurs. In the second embodiment, the given reference value is set to 0.5 [kg/m³].

As a result, when the off gas density calculated does not exceed the given reference value, the process flow returns to Step S200, and if it exceeds, the purging process is performed (S207)

As described above in detail, it is possible to decrease a total amount of the off gas to be exhausted for use in the calculation of, namely for obtaining the off gas density or the hydrogen concentration and to frequently monitor the off gas density by performing the supplemental exhaust with a short period of time through the purging valve 36. It is thereby possible to calculate the off gas density or the hydrogen concentration every a given time. This can obtain a precious value of the off gas density or the hydrogen concentration.

Further, it is possible to perform the purging process when the hydrogen concentration calculated is lower than the given reference value. Because the hydrogen concentration is a reference value for the necessity to initiate the purging, the given hydrogen concentration is set in a range where any voltage drop of the fuel cell 10 does not occur.

### Third Embodiment

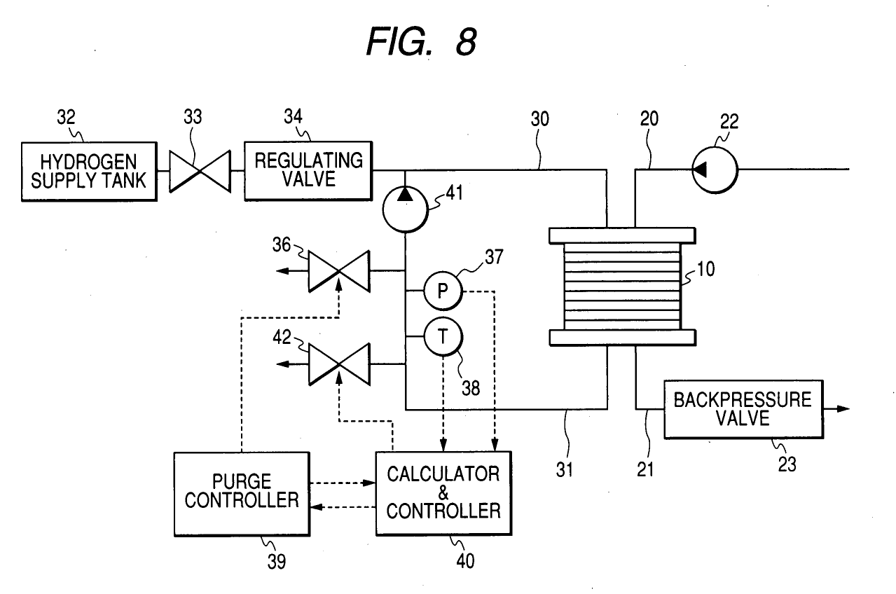

Next, a description will be given of the feature of the fuel cell system according to the third embodiment of the present invention with reference to FIG. 8 and FIG. 11.

When compared with the first and second embodiments, the third embodiment further comprises in configuration a secondary valve with a smaller size in diameter than the purging valve 36.

FIG. 8 is a schematic diagram showing an entire configuration of the fuel cell system according to the third embodiment of the present invention. As shown in FIG. 8, the off gas circulation path 31 of the third embodiment is further equipped with an off gas circulation pump 41 and a secondary valve 42 of a small diameter.

The off gas circulation pump 41 circulates the off gas through the off gas circulation path 31 and the hydrogen supply path 30, and the off gas circulation pump 41 is installed in a junction of the off gas circulation paths 31 and the hydrogen supply path 30.

The secondary valve 42 exhausts a part of the off gas to outside in order to obtain the off gas density and has an orifice diameter (2 mm in the embodiment) that is smaller than the orifice diameter (6 mm in the embodiment) of the purging valve 36.

The flow sectional area of the secondary valve 42 is smaller in size than that of the purging valve 36.

The control to open/close the secondary valve 42 is performed based on the calculation result obtained by the calculator 40 with a control function as the off gas physical property calculator.

The calculator 40 of the embodiment is a concrete example as a hydrogen concentration calculation unit according to the present invention, and the secondary valve 42 of the embodiment is a concrete example of the off gas exhaust unit of the present invention.

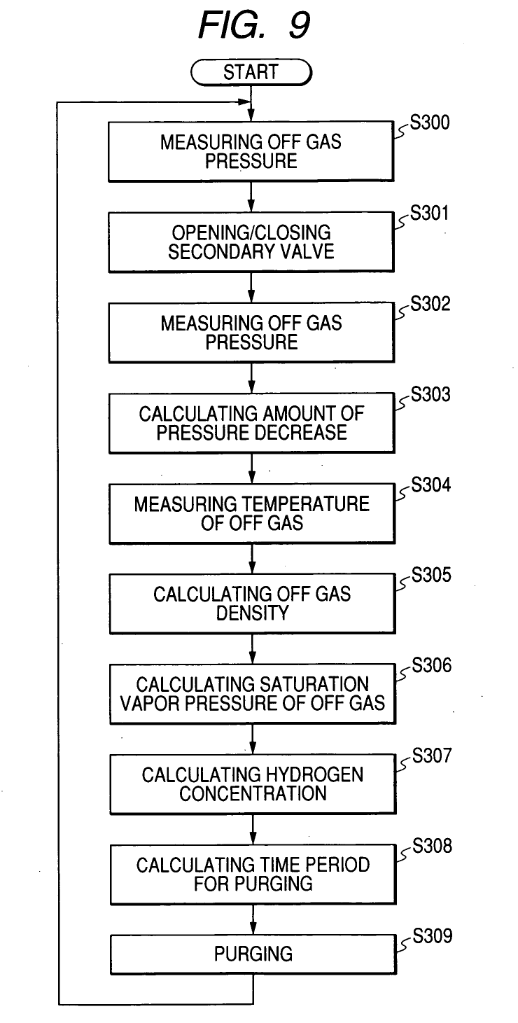

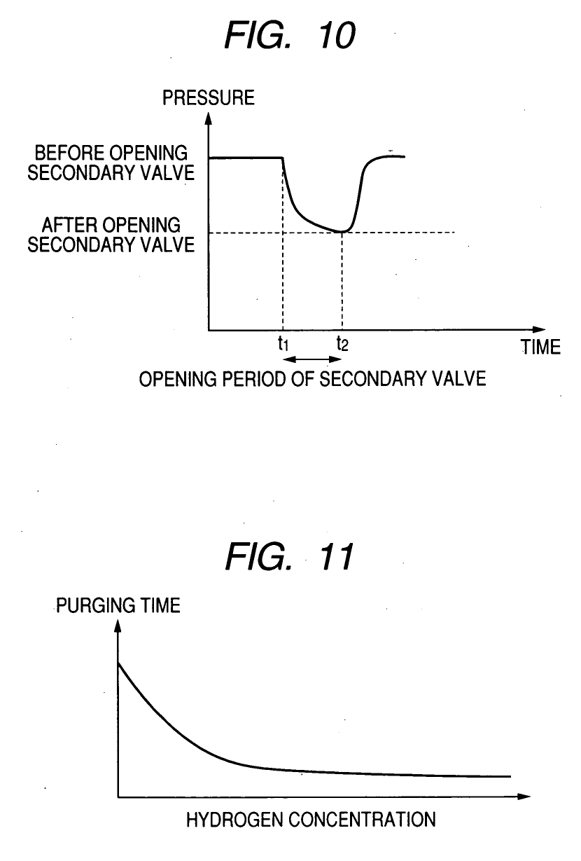

FIG. 9 is a flowchart showing a purging process performed by the purge controller 39 and the calculator 40 of the third embodiment. FIG. 10 is a diagram showing a pressure change of the off gas in the off gas circulation path 31 before and after the exhaust of a part of the off gas through the secondary valve with a small size.

The process of the third embodiment will be performed every a given timing (for example, every five minutes in this embodiment).

First, the pressure sensor 37 measures the off gas pressure before the exhaust of the off gas through the secondary valve 42 (S300). In this embodiment, the pressure sensor 37 measures the off gas pressure at a timing t1 (see FIG. 10) that is immediately before the opening of the secondary valve 42. The secondary valve 42 opens during a given period of time (for 100 msec in the embodiment). In this opening of the secondary valve 42 for the given period of time, because a part of the off gas is exhausted to the outside through the secondary valve 42, a slight amount of the pressure of the off gas is thereby decreased.

Next, the pressure sensor 37 measures the pressure of the off gas immediately following the opening process of the secondary valve 42 (S302). In the embodiment, the opening process means the process from the open of the secondary valve 42 to the closing of the secondary valve 42, and the pressure sensor 37 measures the pressure of the off gas at a timing t2 (see FIG. 10) that is immediately following the closing of the secondary valve 42.

The calculator 40 calculates a pressure decrease of the off gas by subtracting the pressure value of the off gas at the timing t2 from that at the timing t1 (S303). The temperature sensor 38 then measures a temperature of the off gas at the timing t2 (S304). The calculator 40 calculates the off gas density based on the pressure decrease of the off gas and the temperature measured.

Because the calculation process of the off gas density based on the pressure decrease of the off gas in the third embodiment is the same as that of the first and second embodiments, the explanation thereof is omitted here.

The pressure sensor 37 measures the off gas density after the opening of the secondary valve 42 (S302). In this embodiment, the sensor 37 measures the pressure of the off gas at the timing t2 immediately following the closing of the secondary valve 42. The calculator 40 calculates a pressure decrease of the off gas based on a difference between the pressures of the off gas before and after the opening process of the secondary valve 42 (S303). The temperature sensor 38 measures the temperature of the off gas at the timing t2 (S304), and the calculator 40 calculates the off gas density based on the pressure decrease of the off gas and the temperature measured (S305).

Because the calculation process of the off gas density based on the pressure decrease of the off gas in the third embodiment is the same as that of the first and second embodiments, the explanation thereof is omitted here.

Next, the calculator 40 calculates the hydrogen concentration in the off gas using the off gas density, and calculates the molar mass or density of the off gas based on the off gas pressure and the off gas temperature using the equation (1), and calculates the hydrogen concentration in the off gas based on the molar mass calculated and the equation (2). In this case, because the off gas is exhausted to the outside with a water component generated in the fuel cell 10 during the generation of the electrical energy, the off gas contains a water vapor component in saturation. In order to calculate the hydrogen concentration preciously, it is necessary to eliminate the water vapor component from the off gas.

It is possible to calculate the molar mass M of the off gas using the following equation (3) under an assumption that the off gas contains only the hydrogen component, the nitrogen component, and the water vapor component.
M=2×X_{H2}+28×X_{N2}+18×X_{H20} (3),
where because X_{H2}+X_{N2}+X_{H20}=1, a total sum of the hydrogen concentration and the nitrogen concentration becomes X_{H2}+X_{N2}=1−X_{H20} after eliminating the water vapor component.
It is possible to calculate the water vapor concentration X_{H20} in the off gas using the equation X_{H20}=27/200 in the case in which the off gas pressure is 200 kPa·abs and the water vapor pressure is 27 kPa, for example.

The calculator 40 calculates the saturation pressure of the off gas using the off gas temperature measured at Step S304 (S306), and obtains the water vapor pressure in the off gas using the saturation pressure of the water vapor. The calculator 40 then calculates the hydrogen concentration in the off gas using the value in which the water vapor concentration is eliminated from the off gas density (that is equivalent to a molar mass of the off gas) calculated in S304.

Next, the calculator calculates the period of time for opening the purging valve 36 that is the purging period of time using the hydrogen concentration (S308).

FIG. 11 shows a relationship between the hydrogen concentration in the off gas and the purging period of time. As shown in FIG. 11, it is determined that the lower the hydrogen concentration, the longer the purging period of time will be, and, on the contrary, the higher the hydrogen concentration, the shorter the purging period of time will be.

The relationship between the hydrogen concentration and the purging period of time shown in FIG. 11 can be obtained experimentally in advance. In the embodiment a third map or a third table in which the hydrogen concentration is related to the purging period of time is provided and the third map is stored in the ROM in the purging controller 39 in advance. In the third embodiment, the opening period of time of the purging valve 36 is set within a range of 100-500 msec. The purge controller 39 determines the purging period of time using the third map based on the hydrogen concentration calculated by the calculator 40, and instructs the purging valve 36 to perform the purging process.

As described above in detail, by using the secondary valve 42 that is smaller in diameter than the purging valve 36, it is possible to decrease the exhaust amount of the off gas through the secondary valve 42 when compared with the case that calculates the hydrogen concentration using the purging valve 36. It is thereby possible to frequently monitor the off gas density or the hydrogen concentration and to obtain the precious off gas density or the hydrogen concentration.

Furthermore, it is possible to calculate a precious hydrogen concentration from the off gas density by considering the saturation water vapor obtained from the off gas temperature when the hydrogen concentration is calculated based on the off gas density. In addition, it is possible to determine the optimum purging period of time using the hydrogen concentration calculated above. It is thereby possible to suppress the exhaust amount of the hydrogen in the off gas during the purging process and possible to perform the purging before the occurrence of the voltage drop in the fuel cell 10. It is also possible to calculate and determine the purging period of time based on the off gas density as a physical property relating to the hydrogen concentration.

### Fourth Embodiment

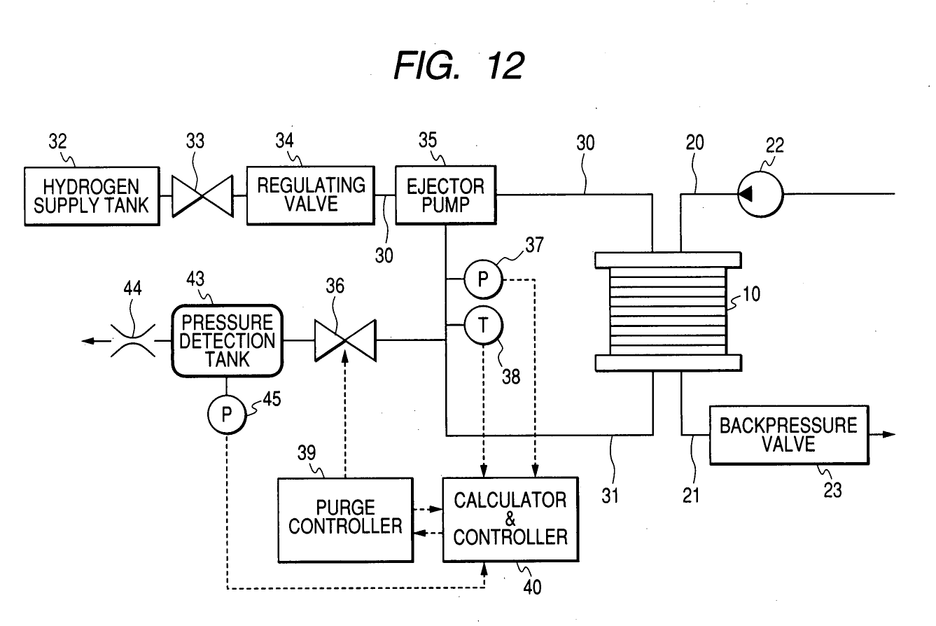

Next, a description will now be given of the feature of the fuel cell system according to a fourth embodiment of the present invention with reference to FIG. 12 and FIG. 15.

When compared with the first to third embodiments, the fourth embodiment further comprises in configuration a pressure detection tank 43 to detect an off gas density.

FIG. 12 is a schematic diagram showing an entire configuration of the fuel cell system according to the fourth embodiment of the present invention. As shown in FIG. 12, a pressure detection tank 43 is placed in a downstream end of the purging valve 36 and the volume of the tank 43 is 0.5 litters, for example, that is smaller than the volume of the off gas circulation path 31, for example 5.0 litters.

An orifice unit 44 is further placed at the outlet of the pressure detection tank 43. The flow sectional area of the orifice unit 44 is smaller than that of the pressure detection tank 43. The orifice unit 44 has a small orifice diameter (1 mm in the embodiment) than the orifice diameter (6 mm in the embodiment) of the purging valve 36. The flow sectional area of the orifice unit 44 is smaller than that of the purging valve 36. The pressure detection tank 43 is usually kept at atmospheric pressure, and the pressure thereof is increased when the purging valve 36 opens and off gas flows into the tank 43.

The pressure detection tank 43 is equipped with a secondary pressure sensor 45 as a secondary pressure detection unit. The secondary pressure sensor 45 measures a pressure of the pressure detection tank 43, and transmits the measured one as a sensor signal to the calculator 40 with a control function as the off gas physical property calculator. In the calculator 40 in the embodiment is also a concrete example as a nitrogen concentration detection unit according to the present invention.

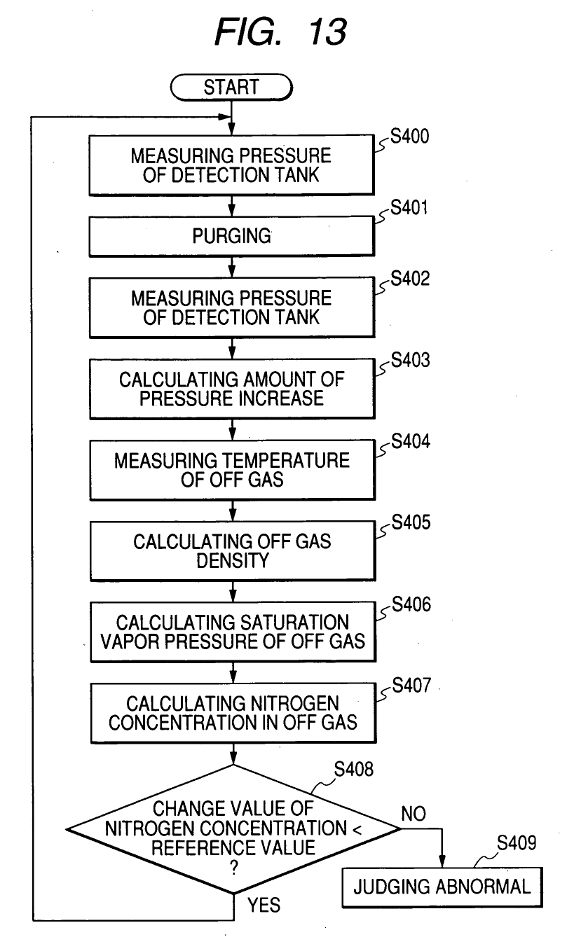

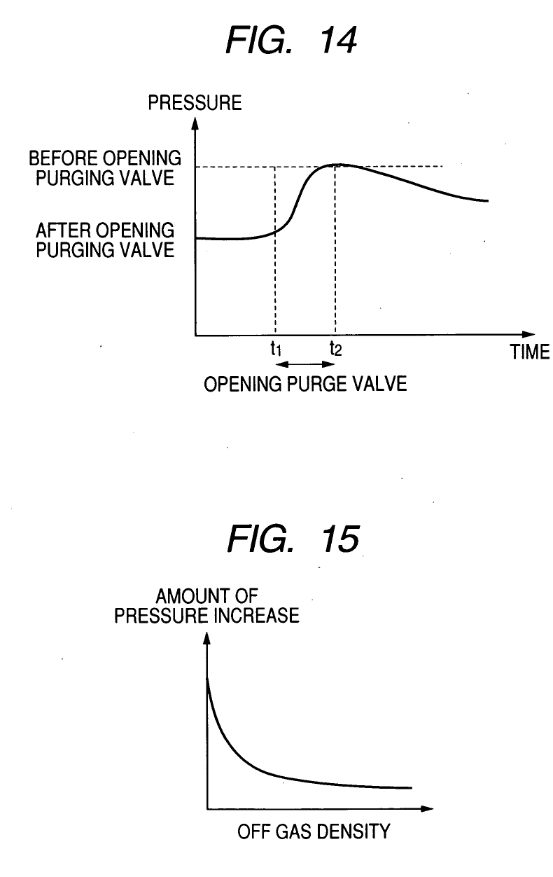

FIG. 13 is a flowchart showing an abnormal state diagnosis process performed by the fuel cell system of the fourth embodiment. FIG. 14 is a diagram showing a pressure change of the off gas before and after the purging in the fourth embodiment.

FIG. 15 is a diagram showing a relationship between a magnitude of a pressure increase in a pressure detection tank and an off gas density of the fourth embodiment. The following process is performed every a given time (for example, every five minutes).

First, the secondary pressure sensor 45 measures the pressure of the pressure detection tank 43 before the purging (S400).

In this embodiment, the pressure sensor 45 measures the pressure at a timing t1 (see FIG. 14) immediately before the opening of the purging valve 36. The purging valve 36 opens during a given period of time (300 m sec in the embodiment) (S401).

Because a part of the off gas in the off gas circulation path 31 is thereby exhausted to the pressure detection tank 43 through the purging valve 36, the pressure of the pressure detection tank 43 increases.

Next, the pressure sensor 45 measures the pressure of the pressure detection tank 43 after the purging (S402). In this embodiment, the pressure sensor 37 measures the pressure in the tank 43 at a timing t2 (see FIG. 14) immediately following the closing of the purging valve 36. The calculator 40 calculates the amount of the pressure increase in the tank 43 using the pressure difference in the tank 43 before and after the purging process (S403), the temperature sensor 38 measures the temperature of the off gas in the off gas circulation path 31 (S404), and the calculator 40 calculates the off gas density based on the temperature measured and the amount of the pressure increase (S405).

FIG. 15 shows a relationship between the off gas density and the amount of the pressure increase in the pressure detection tank 43.

As described above, the molar mass of the off gas flowing through the purging valve 36 depends on the off gas composition (concentration). When the purge valve 36 of a same orifice diameter is open for a given period of time under the same off gas pressure before the opening of the purging valve 36, the lower the off gas density, the greater the molar flow rate of the off gas to be exhausted through the off gas circulation path 31 will be, and the higher the off gas density, the smaller the molar flow rate of the off gas to be exhausted through the off gas circulation path 31 will be.

As shown in FIG. 15, the lower the off gas density, the greater the amount of the pressure increase in the tank 43 will be, because the molar flow rate of the off gas flowing into the tank 43 becomes higher. On the contrary, the higher the off gas density, the smaller the amount of the pressure increase in the tank 43 will be, because the molar flow rate of the off gas flowing into the tank 43 becomes lower. In other words, the higher the hydrogen concentration in the off gas, the smaller the amount of the pressure increase in the pressure detection tank 43 will be. The lower the hydrogen concentration, the greater the amount of the pressure increase in the tank 43 will be.

The fourth embodiment makes a fourth map (or a fourth table) in which the off gas density, the amount of the pressure increase in the tank 43 before and after the purging, and the off gas pressure before the purging are related in advance, and stored in the ROM in the calculator 40. The calculator 40 calculates the off gas density using the fourth map based on the amount of the pressure increase in the tank 43 calculated at S403, and thereby obtains the off gas density after the purging process.

Next, the calculator 40 calculates the saturation water vapor pressure (S406) using the off gas temperature measured at S404, and calculates the water vapor concentration in the off gas using the saturation water vapor pressure. The calculator 40 then calculates the nitrogen concentration in the off gas using the value obtained by subtracting the water vapor concentration from the off gas density (S407). The nitrogen concentration can be obtained by using the same manner to calculate the hydrogen concentration in the third embodiment.

Next, the calculator 40 calculates a change rate of the nitrogen concentration, namely the interval of the purging process (five minutes in this embodiment) based on the nitrogen concentration calculated at S407 and the nitrogen concentration in the previous purging process, and judges whether or not the change rate of the nitrogen concentration does not exceed a given reference value (S408). In the embodiment, the given reference value is thirty percentage of the increasing rate of the nitrogen concentration. As a result, when the change rate of the nitrogen concentration is lower than the given reference value, the operation flow goes to S400. On the contrary, when it is not lower than the given reference value, namely exceeds the given reference value, it is judged to occur the abnormal stare in the fuel cell 10 (S409).

That is, although the nitrogen concentration in the off gas increases gradually with the passage of the generation of the electrical energy in the fuel cell 10, when the increasing rate of the nitrogen concentration in the off gas exceeds the given reference value (thirty percentage thereof in the embodiment) as the increasing rate of the nitrogen concentration in the off gas, it is possible to determine that the amount of crossleakage becomes overload in the fuel cell 10. In this case, it is judged that the abnormal state occurs because it can be considered the electrolyte membrane failure and the like occurs.

As described above in detail, it is possible to increase the magnitude of the pressure change before and after the purging in the pressure detection tank 43 whose volume is smaller than that of the off gas circulation path 31. It is thereby possible to obtain a precious off gas density or the hydrogen concentration.

Further, it is possible to increase efficiently the pressure in the pressure detection tank 43 when the off gas is exhausted from the off gas exhaust unit having the pursing valve 36 and the secondary valve 42 because the orifice unit 44 whose flow sectional area is smaller than that of the purging valve 36 and secondary valve 42 is mounted on the downstream end of the tank 43 in the third embodiment.

In addition, because the concentration of the nitrogen as an impurity in the off gas is obtained based on the off gas density, it is possible to perform the precious abnormal judgment for the fuel cell 10 based on the change rate of the nitrogen concentration per unit time, for example. It is further possible to perform the judgment of the abnormal state of the fuel cell 10 such as a failure of the electrolyte membrane using the change rate per unit time of the off gas density or the hydrogen concentration as a physical property relating to the nitrogen concentration.

### Fifth Embodiment

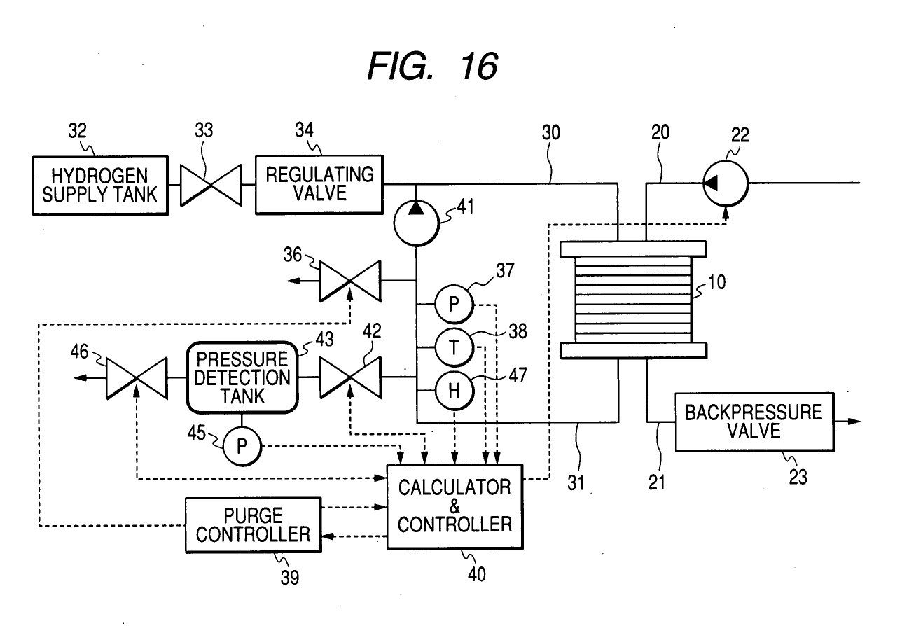

A description will now be given of the feature of the fuel cell system according to the fifth embodiment of the present invention with reference to FIG. 16 to FIG. 18.

When compared with the fourth embodiments, the fifth embodiment has the pressure detection tank 43 placed at the downstream end of the secondary valve 42 and further comprises a humidity sensor 47 as a humidity detection unit mounted in the off gas circulation path 31.

FIG. 16 is a schematic diagram showing an entire configuration of the fuel cell system of the fifth embodiment.

In the fifth embodiment shown in FIG. 16, the pressure detection tank 43 is placed at the downstream end of the secondary valve 42.

The secondary valve 42 and the pressure detection tank 43 are in function the same of those of the third and fourth embodiments, respectively. As a different matter, the pressure detection tank 43 of the fifth embodiment has 0.1 liters in volume, because the tank 43 is placed at the downstream end of the secondary valve 42 of a small orifice size.

An outlet valve 46 is placed at the downstream end of the tank 43. Through the outlet valve 46 the tank 43 is open to the outside and closed from the outside. The calculator 40 as the off gas physical property calculator has the function to control the opening/closing operation of the outlet valve 46.

The outlet valve 46 is closed while the pressure sensor 45 measures the pressure of the tank 43 and is open to the outside after the pressure sensor 45 measures the pressure of the tank 43 in order to keep the tank 43 at the atmosphere pressure.

The humidity sensor 47 placed in the off gas circulation path 31 measures a humidity of the off gas. The value of the humidity measured is transferred as a sensed signal to the calculator 40. Thus, the calculator 40 acts as a concrete example of an electrical energy generation permission unit according to the present invention, and the humidity sensor 47 is a concrete example of the off gas humidity detection unit of the present invention.

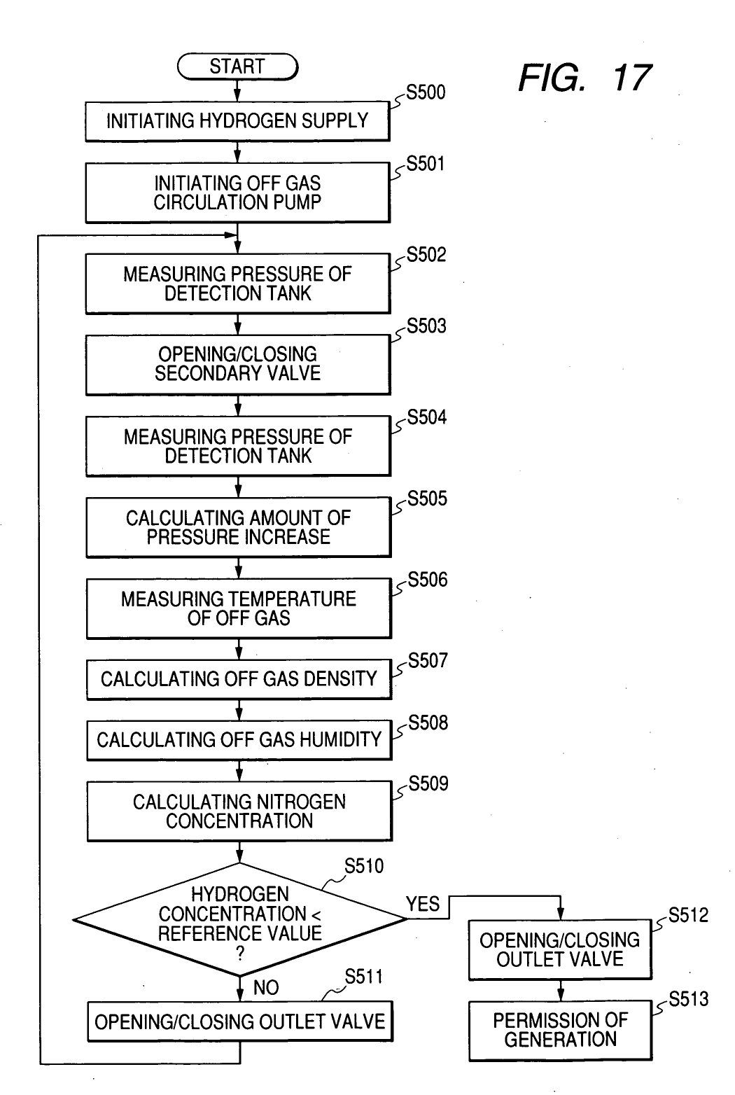

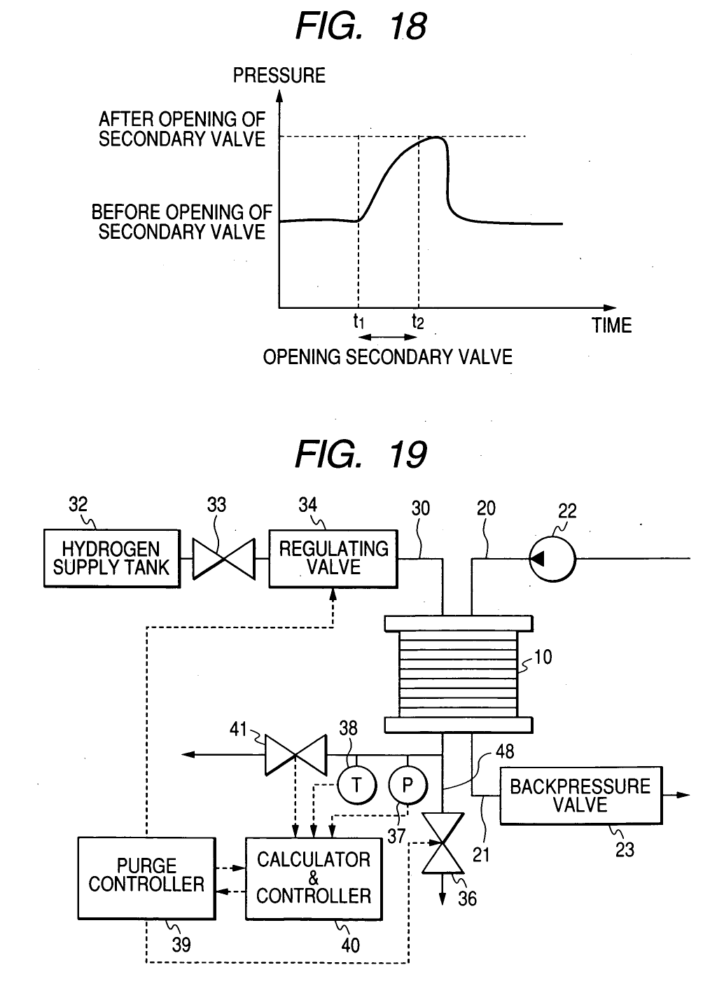

FIG. 17 is a flowchart showing the electrical energy generation permission process for the fuel cell 10 performed by the purge controller 39 and the calculator 40 as the electrical energy generation permission unit. FIG. 18 is a diagram showing a pressure change in the pressure detection tank 43 before and after the opening of the secondary valve 42.

The generation permission process is performed just at the time to initiate the generation of the electrical energy in the fuel cell 10.

Before the electrical energy generation, the inside of the fuel cell 10 is filled with impurities other than the hydrogen.

First, the hydrogen supply tank 32 initiates the supply of the hydrogen to the fuel cell 10 (S500), and the off gas circulation pump 41 initiates in operation (S501). The hydrogen is thereby supplied to the inside of the fuel cell 10 and the off gas circulation path 31.

Following, the pressure sensor 45 measures the pressure in the pressure detection tank 43 before the opening of the secondary valve 42 (S502). In the embodiment, the pressure sensor measures the pressure of the tank 43 at a timing t1 (see FIG. 18) immediately before the pre-opening of the secondary valve 42. The calculator 40 as the controller instructs the secondary valve 42 to open for a given period of time (100 m sec in the embodiment) (S503). A part of the off gas is exhausted from the off gas circulation path 31 to the tank 43, and the pressure of the tank 43 thereby increases.

Next, the pressure sensor 45 measures the pressure of the tank 43 after the opening of the secondary valve 42 (S504). In the embodiment, the pressure sensor 45 measures the pressure of the tank 43 at the timing t2 (see FIG. 18) immediately following the closing of the secondary valve 42. In the embodiment, the opening process means the process from the open of the secondary valve 42 to the closing of the secondary valve 42. The calculator 40 calculates a pressure decrease of the pressure detection tank 43 based on a pressure difference of the opening and closing of the secondary valve 42 (S505). The temperature sensor 38 measures the temperature of the off gas (S506). The calculator 40 calculates the off gas density based on the pressure decrease of the pressure detection tank 43. Since the calculation process of the off gas density based on the magnitude of the pressure decrease of the tank 43 is the same as that in the fourth embodiment, the explanation thereof is omitted here.

Following, the humidity sensor 47 measures the humidity of the off gas in the circulation path 31 (S508). The calculator 40 calculates the water vapor concentration from the off gas humidity measured, and calculates the hydrogen concentration in the off gas based of a difference value obtained by subtracting the water vapor concentration from the off gas density calculated at S507 (S509).

The calculator with the control function judges whether or not the hydrogen concentration in the off gas exceeds a given reference value (S510). In the embodiment the given reference value is a value of fifty percentages of the off gas density.

As a result, when the hydrogen density calculated does not exceed the given reference value, the calculator 40 with the control function instructs the outlet valve 46 so as to open the valve 46. The pressure detection tank 43 is thereby filled with the air at the atmosphere pressure (S511). The operation flow returns to S502.

On the contrary, when the hydrogen density calculated exceeds the given reference value, the calculator 40 with the control function instructs the outlet valve 46 so as to open the valve 46. The pressure detection tank 43 is thereby filled with the air at the atmosphere pressure (S512). The calculator 40 with the control function permits the generation of the electric energy to the fuel cell 10. That is, the calculator 40 instructs the compressor 22 (as the air supply device) to initiate the supply of the air to the fuel cell 10, and the fuel cell 10 thereby initiates the generation of the electrical energy (S513).

As described above in detail, because the outlet valve 46 placed at the downstream end of the pressure detection tank 43 is closed during the opening of the secondary valve 42, easy increase of the pressure of the tank 43 can be achieved and it is possible to obtain preciously the amount of the pressure increase in the tank 43 during the opening process of the secondary valve 42, namely from the timing t1 to the timing t2.

Further, the water vapor concentration in the off gas is obtained directly because the humidity sensor 47 measures the humidity of the off gas.

Furthermore, it is possible to obtain a precious hydrogen concentration in the off gas because the hydrogen concentration is calculated based on the off gas density and the humidity of the off gas in the fifth embodiment.

Still furthermore, the fuel cell system is equipped with the calculator 40 as the generation permission unit to judge the permission of the generation of the electrical energy in the fuel cell 10 based on the hydrogen concentration in the off gas or the off gas density relating to the hydrogen concentration. The permission of the generation of the electrical energy in the fuel cell 10 can be thereby judged based on the off gas density or the hydrogen concentration in the off gas in order to determine the optimum time to initiate the generation of the electrical energy in the fuel cell 10.

### Sixth Embodiment

A description will now be given of the feature of the fuel cell system according to the sixth embodiment of the present invention with reference to FIG. 19 to FIG. 21.

The fuel cell system of the sixth embodiment is a system of a closing type in which the off gas is not circulated.

FIG. 19 is a schematic diagram showing the entire configuration of the fuel cell system of a closing type according to the sixth embodiment of the present invention. As shown in FIG. 19, the fuel cell system is equipped with an off gas exhaust path 48 through which the off gas provided from the hydrogen electrode end in the fuel cell 10 is exhausted to outside.

The off gas exhaust path 48 is equipped with a purging valve 36 that is the same in configuration of the purging valve 36 of the first to fifth embodiment, and further with the secondary valve 42 of a small diameter size placed between the fuel cell 10 and the purging valve 36. Still further, the fuel cell system of the sixth embodiment is equipped with the pressure sensor 37, whose configuration is the same of those in the first to fifth embodiments), to measure the pressure of the off gas in the off gas exhaust path 48.

The configuration and function of the purging valve 36, the secondary valve 42, and the pressure sensor 37 are the same of those in the first to fifth embodiments.

The purging controller 39 is configured to control the outlet pressure of the regulating valve 34. The regulating valve 34 and the purge controller 39 form a concrete example of the hydrogen supply pressure control unit according to the present invention.

During the normal operation of the fuel cell system of the embodiment, namely through the electrical energy generation operation, the purging valve 36 is closed.

With the passage of time of the generation of the electrical energy in the fuel cell 10, impurities such as nitrogen are accumulated at the hydrogen electrode end of the fuel cell 10, so that the concentration of the impurities contained in the off gas exhausted from the fuel cell 10 is increased. The system of the sixth embodiment is so formed to initiate the purging through the purging valve 36 when the impurity concentration in the off gas is increased.

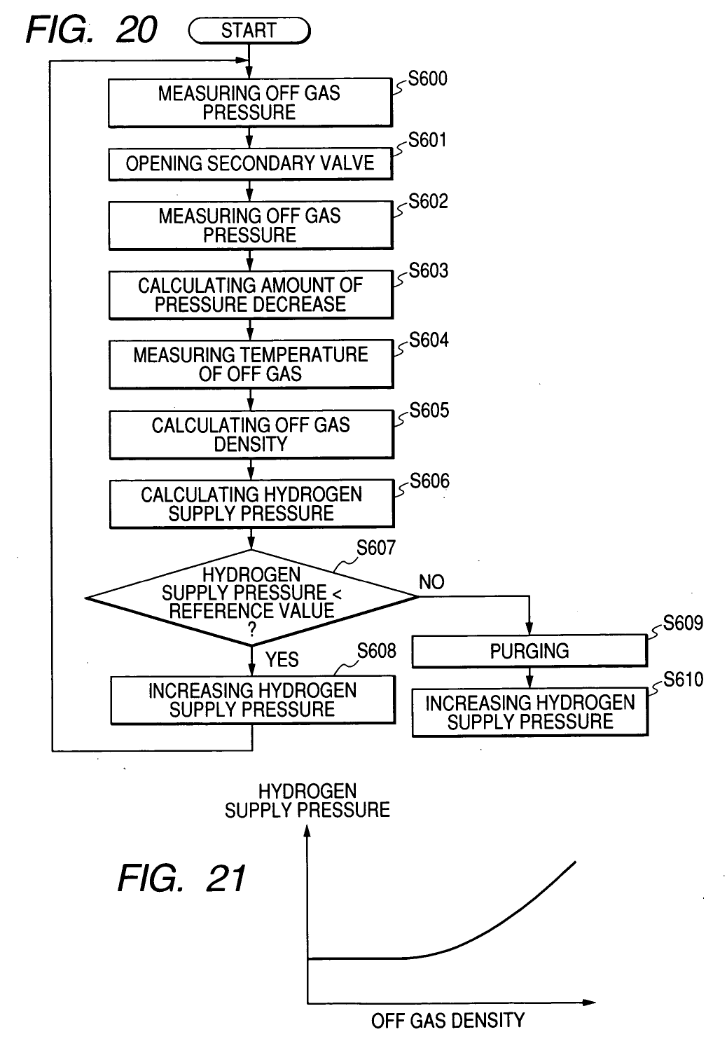

FIG. 20 is a flow chart showing the purging process performed by the purge controller 39 and the calculator 40 with the control function according to the sixth embodiment.

First, the pressure sensor 37 measures the pressure of the off gas before the opening of the secondary valve 42 (S600).

The secondary valve 42 opens for a given period of time (100 m sec in the embodiment) (S601). A part of the off gas is thereby exhausted from the off gas exhaust path 48 to the outside and a slightly pressure decrease of the off gas occurs.

Next, the pressure sensor 37 measures the pressure of the off gas after the opening of the secondary valve 42 (S602).

The calculator 40 calculates the magnitude of the pressure decrease based on a difference of the pressures of before and after the opening of the secondary valve 42 (S603). The temperature sensor 38 measures the temperature of the off gas (S604). The calculator 40 calculates the of gas density based on the magnitude of the pressure decrease of the off gas (S605). The calculation process of the off gas density based on the pressure decrease of the off gas is the same as that of the first to fifth embodiments and so the explanation thereof is omitted here.

Following, the calculator 40 calculates a necessary supply amount of the hydrogen for the optimum electrical energy generation in the fuel cell 10 based on the off gas density (S606).

FIG. 21 is a diagram showing a relationship between the off gas density and a necessary supply pressure of the hydrogen to the fuel cell 10.

As shown in FIG. 21, there is a correlation between the off gas density and the necessary supply pressure of the hydrogen. In a concrete example, the necessary supply pressure becomes low under a condition where the hydrogen concentration is high and the off gas density is low. On the contrary, under a condition where the hydrogen concentration is low and the off gas density is high, the necessary supply pressure becomes high in order to keep constant the output of the electrical energy from the fuel cell 10. In the sixth embodiment, a fifth map or a fifth table is made in advance, in which the off gas density and the optimum supply pressure of the hydrogen to the fuel cell 10 are related. This fifth map is stored in a ROM (omitted from drawings) in the calculator 40. The calculator 40 calculates the optimum supply pressure of the hydrogen based on the off gas density calculated at S604 using the fifth map stored in the ROM.

Next, the calculator 40 judges whether or not the pressure supply amount of the hydrogen to the fuel cell 10 does not exceed a given reference value (S607). This given reference value indicates the upper limit pressure permitting the use of the electrolyte membrane in the fuel cell 10. The given reference value is 300 kPa in the embodiment. As a result, when the calculator 40 judges that the supply amount of the hydrogen to the fuel cell 10 does not exceed the given reference value (300 kPa), the calculator indicates the purge controller 39 so that the amount of the supply pressure of the hydrogen at the outlet of the regulating valve 34 is set to high. The hydrogen of a higher pressure is thereby supplied to the fuel cell 10 through the regulating valve 34 (S608).

On the contrary, when the calculator 40 judges that the supply amount of the hydrogen to the fuel cell 10 exceeds the given reference value (300 kPa), the calculator indicates the purge controller 39 so that the purging valve 36 performs the purging for a given period of time (S609). A part of the off gas is thereby exhausted from the off gas exhaust path 48 to the outside, and new hydrogen is supplied to the fuel cell 10 form the hydrogen supply tank 32 through the regulating valve 34 and the hydrogen supply path 30. The calculator 40 with the control function transfers an instruction to the purge controller 39 so that the supply amount of the hydrogen from the outlet of the regulating valve 34 is initialized as set to an initial value. The supply pressure of the hydrogen to the fuel cell 10 is decreased (S610).

As described above in detail, it is possible to obtain the off gas density or the hydrogen concentration based on the magnitude of the pressure change of the off gas caused by opening/closing the secondary valve 42. The calculator 40 controls constant the supply pressure of the hydrogen to the fuel cell 10 based on the supply pressure of the hydrogen calculated using the off gas density or the hydrogen concentration while keeping constant the off gas density or the hydrogen concentration.

Further, the hydrogen supply pressure control unit has the regulating valve 34 and the purge controller 39 controls the supply amount of the hydrogen to the fuel cell 10 based on the off gas density or the hydrogen concentration in the off gas. It is thereby possible to determine the optimum supply pressure of the hydrogen based on the off gas density or the off gas concentration in the off gas, and to supply the hydrogen at the necessary supply pressure to the fuel cell 10.

### OTHER EMBODIMENTS IN INDUSTRIAL APPLICABILITY

According to the present invention, it is possible to combine optionally the first to sixth embodiments in configuration and operation.

Further, because the off gas density used through the first to sixth embodiments is a physical property relating to a hydrogen concentration in a off gas, it is possible to switch the use of the off gas density with the hydrogen concentration in each embodiment. Similarly, because a nitrogen density (or an impurity concentration) in the off gas is also a physical property relating to the hydrogen concentration in the off gas, it is also possible to switch the use of the nitrogen concentration with the hydrogen concentration in each embodiment.

Furthermore, it is suitably possible to apply the fuel cell system of the present invention as an electric power source to a movable body such as an electric vehicle, a ship, portable generators, and small-sized generators for home use.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalent thereof.

What is claimed is:

1. A fuel cell system having a fuel cell generating an electrical energy in an electrochemical reaction of hydrogen and oxygen therein, comprising:
an off gas path through which an off gas exhausted from the fuel cell flows, the off gas containing impurities other than the hydrogen and a residual hydrogen not reacted during the electrochemical reaction in the fuel cell;
an off gas exhaust unit exhausting the off gas from the off gas path to outside during a first period of time;
an off gas pressure detector detecting an off gas pressure value in the off gas path; and
an off gas physical property calculator configured to calculate a change value between off gas pressure values before and after the purging of the off gas performed through the off gas exhaust unit, and to calculate an off gas density based on the change value and the off gas pressure value before the purging.

2. A fuel cell system having a fuel cell generating an electrical energy in an electrochemical reaction of hydrogen and oxygen therein, comprising:
an off gas path through which an off gas exhausted from the fuel cell flows, the off gas containing impurities other than the hydrogen and a residual hydrogen not reacted during the electrochemical reaction in the fuel cell;
an off gas exhaust unit exhausting the off gas from the off gas path to outside during a first period of time;
an off gas pressure detector detecting an off gas pressure value in the off gas path; and
an off gas pressure change calculation means calculating a change value between off gas pressure values before and after the purging of the off gas performed through the off gas exhaust means; and
an off gas density calculating means calculating an off gas density based on the change value and the off gas pressure value before the purging.

3. The fuel cell system according to claim 1, wherein the off gas physical property calculator calculates a hydrogen concentration contained in the off gas based on the off gas density calculated.

4. The fuel cell system according to claim 3, further comprising an off gas temperature detector, placed on the off gas path, configured to detect a temperature of the off gas,
wherein the off gas physical property calculator calculates the hydrogen concentration contained in the off gas based on the off gas temperature detected and the off gas density calculated.

5. The fuel cell system according to claim 3, further comprising an off gas humidity detection unit, mounted on the off gas path, configured to detect a humidity of the off gas,
wherein the off gas physical property calculator calculates the hydrogen concentration contained in the off gas based on the off gas humidity detected and the off gas density calculated.

6. The fuel cell system according to claim 1, wherein the off gas exhaust unit comprises a purging valve purging to the outside a part of the off gas for the first period of time as to eliminate the impurities from the off gas.

7. The fuel cell system according to claim 1, wherein the off gas exhaust unit comprises a purging valve purging to the outside a part of the off gas for a second period of time so as to eliminate the impurities from the off gas, and the second period of time is longer than the first period of time.

8. The fuel cell system according to claim 1, further comprising a purging valve purging to the outside a part of the off gas for a second period of time so as to eliminate the impurities from the off gas, and
wherein the off gas exhaust unit comprises a secondary valve whose diameter is smaller than the purging valve.

9. The fuel cell system according to claim 1, wherein the off gas physical property calculator calculates the change value between off gas pressure values detected before and after the exhaust of the off gas by the off gas pressure detector.

10. The fuel cell system according to claim 1, further comprising:
a pressure detection tank, placed in the off gas path, whose volume is smaller than that of the off gas path; and
a secondary pressure detection unit configured to detect a pressure value in the pressure detection tank,
wherein the off gas physical property calculator calculates a change value of the pressure in the pressure detection tank before and after the exhaust of the off gas from the off gas exhaust unit.

11. The fuel cell system according to claim 10, further comprising an orifice unit, placed in the downstream end of the pressure detection tank, whose flow sectional area is smaller than that of the off gas path.

12. The fuel cell system according to claim 10, further comprising an outlet valve whose flow sectional area is smaller than that of the off gas path.

13. The fuel cell system according to claim 6, further comprising a purge control unit configured to control opening and closing of the purging valve,
wherein the purge control unit determines a timing to initiate the pursing operation of the purging valve based on the off gas density calculated by the off gas physical property calculator.

14. The fuel cell system according to claim 6, further comprising a purge control unit configured to control opening and closing of the purging valve,
wherein the purge control unit instructs the purging valve to perform the pursing operation based on a case when the off gas density calculated by the off gas physical property calculator exceeds a given off gas density.

15. The fuel cell system according to claim 6, further comprising a purge control unit configured to control opening and closing of the purging valve,
wherein the purge control unit determines a timing period to perform the pursing operation of the purging valve based on the off gas density calculated by the off gas physical property calculator.

16. The fuel cell system according to claim 5, further comprising a purge control unit configured to control opening and closing of the purging valve,
wherein the purge control unit determines a timing to initiate the pursing of the purging valve based on the hydrogen concentration in the off gas calculated by the off gas physical property calculator.

17. The fuel cell system according to claim 6, further comprising a purge control unit configured to control opening and closing of the purging valve,
wherein the purge control unit instructs the purging valve to perform the pursing if the hydrogen concentration in the off gas calculated by the off gas physical property calculator is lower than a given hydrogen concentration.

18. The fuel cell system according to claim 6, further comprising a purge control unit configured to control opening and closing of the purging valve,
wherein the purge control unit determines a timing period to perform the pursing of the purging valve based on the hydrogen concentration in the off gas calculated by the off gas physical property calculator.

19. The fuel cell system according to claim 7, further comprising a hydrogen supply pressure control unit configured to control a pressure value of the hydrogen to be supplied from a hydrogen supply tank to the fuel cell,
wherein the hydrogen supply pressure control unit controls the pressure value of the hydrogen to be supplied to the fuel cell based on the off gas density calculated by the off gas physical property calculator.

20. The fuel cell system according to claim 19, wherein the hydrogen supply pressure control unit controls the pressure value of the hydrogen to be supplied so as to keep the pressure value of the hydrogen constant.

21. The fuel cell system according to claim 6, further comprising a hydrogen supply pressure control unit configured to control a pressure value of the hydrogen to be supplied from a hydrogen supply tank to the fuel cell,
wherein the hydrogen supply pressure control unit controls the pressure value of the hydrogen to be supplied to the fuel cell based on the hydrogen concentration in the off gas calculated by the off gas physical property calculator.

22. The fuel cell system according to claim 21, wherein the hydrogen supply pressure control unit controls the pressure value of the hydrogen to be supplied so as to keep constant the hydrogen concentration in the off gas.

23. The fuel cell system according to claim 1, further comprising an electrical energy generation permission unit configured to permit the generation of the electrical energy in the fuel cell based on the off gas density calculated by the off gas physical property calculator.

24. The fuel cell system according to claim 3, further comprising an electrical energy generation permission unit configured to permit the generation of the electrical energy in the fuel cell based on the hydrogen concentration in the off gas calculated by the off gas physical property calculator.

25. The fuel cell system according to claim 1, further comprising an abnormal state diagnosis unit configured to detect a change rate of, per time, the off gas density calculated by the off gas physical property calculator, and to diagnose an abnormal state of the fuel cell based on the change rate of the off gas density.

26. The fuel cell system according to claim 1, further comprising an abnormal state diagnosis unit configured to detect a charge rate of, per time, the hydrogen concentration in the off gas calculated by the off gas physical property calculator, and to diagnose an abnormal state of the fuel cell based on the change rate of the hydrogen concentration.

27. The fuel cell system according to claim 1, wherein the off gas physical property calculator calculates a concentration of impurities contained in the off gas other than the hydrogen based on the off gas density calculated, and
the system further comprises an abnormal state diagnosis unit configure to detect a charge rate of, per time, the impurity concentration calculated by the off gas physical property calculator, and to diagnose an abnormal state of the fuel cell based on the change rate of the impurity concentration in the off gas.

28. A movable body equipped with the fuel cell system with the fuel cell as an electric power source according to claim 1, being in operable using an electric power generated by the fuel cell.

29. The fuel cell system according to claim 1, wherein the off gas path is configured to circulate the off gas to the fuel cell.

30. The fuel cell system according to claim 17, wherein the off gas is exhausted through the off gas path without circulation.

31. A method of controlling a generation of electrical energy in a electrochemical reaction of hydrogen and oxygen in a fuel cell system equipped with a fuel cell in which an off gas contains impurities other than a hydrogen and a residual hydrogen not reacted in the electrochemical reaction in the fuel cell and a part of the off gas is exhausted to outside through an off gas path,
the method comprising steps of:
detecting a pressure value of the off gas in the off gas path;
calculating a change value between off gas pressure values before and after the exhaust of the off gas;
calculating an off gas density based on the change value calculated and the off gas pressure value detected before the exhaust;
detecting an off gas pressure value in the off gas path; and
performing a purging of the off gas for a given period of time based on the pressure value of the off gas, the change value of the pressure values, and the off gas density.

32. The method according to claim 31, further comprising steps of:
calculating a hydrogen concentration contained in the off gas based on the off gas density;
detecting an off gas temperature; and
calculating the hydrogen concentration contained in the off gas based on the off gas temperature detected and the off gas density.

33. The method according to claim 31, further comprising steps of:
calculating a hydrogen concentration contained in the off gas based on the off gas density;
detecting a humidity of the off gas; and
calculating the hydrogen concentration contained in the off gas based on the off gas humidity detected and the off gas density.

34. The method according to claim 31, further comprising steps of:
purging to outside a part of the off gas for a purging period of time as to eliminate the impurities from the off gas; and
exhausting a part of the off gas for a period of time that is shorter than the purging period of time.

35. The method according to claim 31, further comprising steps of:
detecting a pressure value in a pressure detection tank placed in the off gas path, whose volume is smaller than that of the off gas path; and
calculating a change of the pressure value in the pressure detection tank before and after the exhaust of the off gas.

36. The method according to claim 31, wherein the initiation of the purging is determined based on the off gas density.

37. The method according to claim 31, wherein the purging is performed when the off gas density exceeds a given off gas density.

38. The method according to claim 31, wherein a purging period of time performing the purging is determined based on the off gas density.

39. The method according to claim 31, further comprising a step of permitting generation of an electrical energy in the fuel cell based on the off gas density.

40. The method according to claim 31, further comprising steps of:
detecting a change rate of the off gas density per time; and
diagnosing an abnormal state of the fuel cell based on the change rate of the off gas density.
